(19) United States
(12) Patent Application Publication
(10) Pub. No.: US 2009/0019875 A1
(43) Pub. Date: Jan. 22, 2009

(54) A/V COOLING SYSTEM AND METHOD

(75) Inventors: James R. Fink, Exeter, RI (US); James W. VanGilder, Pepperell, MA (US); John H. Bean, JR., Wentzille, MO (US)

Correspondence Address: LOWRIE, LANDO & ANASTASI, LLP, ONE MAIN STREET, SUITE 1100, CAMBRIDGE, MA, 02142, US

(73) Assignee: AMERICAN POWER CONVERSION CORPORATION, West Kingston, RI (US)

(21) Appl. No.: 11/780,136

(22) Filed: Jul. 19, 2007

(51) Int. Cl. F25D 17/00; F25B 49/00; F25B 49/02; G01K 13/00; F25D 23/12

(52) U.S. Cl. 62/259.2; 62/177; 62/129; 62/176.6

(57) ABSTRACT

An audio-visual support and cooling system to maintain A/V equipment at a desired condition. The system comprises a housing unit configured to support at least one unit of A/V equipment. The housing includes a refrigerant inlet, a refrigerant outlet, and a plurality of structural elements configured to define a configuration of the housing, wherein at least one structural element of the plurality of structural elements includes a refrigerant path configured to direct a refrigerant through the at least one structural element between the refrigerant inlet and the refrigerant outlet. Other embodiments and methods are disclosed.

### BACKGROUND OF INVENTION

1. Field of Invention

Embodiments relate generally to apparatuses and methods for cooling electronic equipment. Specifically, embodiments relate to cooling audio-visual equipment without generating unacceptable noise.

2. Discussion of Related Art

Similar to most electronic equipment, consumer and professional audio-visual (A/V) equipment (e.g., stereo receivers, media players/recorders, public address (PA) systems, DVD, CD, DAT (digital audio tape), special effects encode/decode, analog to digital and digital to analog conversion, flash and hard disk memory devices, editing/mastering equipment may be adversely affected by heat, such as heat generated by the operation of the A/V equipment. Such adverse effects are of particular concern for high density and high power usage equipment that is becoming more typical of high-end consumer and professional A/V equipment. A typical storage configuration for multiple pieces of A/V equipment includes a shelving or rack-type housing unit in which multiple pieces of A/V equipment are stored and operated together. Such combined operation increases potential heat related problems associated with A/V equipment.

To alleviate heat produced by such A/V equipment, one approach is to rely upon internal A/V equipment fans and/or heat sinks to dissipate sufficient heat from the equipment to the surrounding rack or surrounding space outside the rack. However, such methods rely substantially on conduction of heat through the walls of the room in which the rack is installed to ultimately remove heat. Since building walls are often designed to have deliberately high thermal resistance for the purpose of minimizing air conditioning and heating load, the ability of a wall to conduct heat away from the A/V equipment being cooled may be limited. Therefore, while this method may be successfully employed for some low power A/V equipment (e.g., up to hundreds of watts) in lower density configurations, it may be unsuccessful in accommodating large heat loads (e.g., thousands of watts) and/or high density configurations. When this method of cooling is attempted with such high power and/or high density A/V equipment, the result may be a steadily escalating ambient temperature in the room where the A/V equipment is located until such point as heat loss through the walls of the room is equal to the rate of heat introduction from A/V equipment. This temperature may be so high as to cause temporary malfunction or permanent damage to the A/V equipment.

To address this heat problem, some have used a building cooling system to introduce cool air into the room containing the A/V equipment and an air handling unit or other heat transfer machinery located elsewhere in the building to expel hot air from the room. In such methods, heat is carried away from the A/V equipment by movement of room air and is then ultimately rejected to the outdoors by another media such as chilled water, refrigerant, or condenser water that cools the hot air. Such building cooling systems generally are not designed to accommodate heat loads beyond that generated from personnel occupancy, environmental, and lighting. Therefore, the placement of additional heat load from A/V equipment operating in the building may result in overloading, tripping offline as a protective action, and/or causing permanent damage and failure of the building cooling system. Further, building cooling systems are often not designed to be operable year-round, yet there is nearly always an expectation that A/V equipment be available for use during all seasons of the year. Furthermore, due to the extremely high audio dynamic range with which high-end A/V equipment is capable of operating, any noise from sources other the A/V media itself may be regarded as objectionable and often unacceptable by users of the equipment, so noise associated with forced movement of air, and therefore such building cooling systems may be judged to be an excessive and undesired source of noise, thereby prohibiting use for cooling in the room in which the A/V equipment is located.

Others have addressed the cooling of such A/V equipment by using a specialized device to remove heat from the A/V equipment, such as fans or compressors, installed in the vicinity of the A/V equipment, that convey heat out of the room by way of chilled water, air, refrigerant, or condenser water. Such fans and/or compressor(s) at the point of cooling generate noise near the A/V equipment. Due to the close proximity of such systems to the A/V equipment, the sound generated by the cooling system may often be judged to be unacceptable by users of A/V equipment.

Still others have addressed the heat of A/V equipment by using exhaust fans arranged in the room in which the A/V equipment is located. Heat may be removed from the space housing the A/V equipment by way of a simple fan and ducting arrangement. This method, however, suffers from noise caused by air movement which may be unacceptable to users of the A/V equipment. Also, when air is withdrawn from the space to be cooled, the air must be replaced by air from another source. The system may be arranged such that this source is from another adjoining space in the same building, the outdoors or elsewhere. The problem with this method is that the source of replacement air is often unconditioned, and therefore operation of the exhaust fan may result in significantly increased load on the building cooling system. If a building cooling system does not exist or is overloaded, the A/V equipment room could undergo a significant departure from desired temperature and humidity conditions.

### SUMMARY OF INVENTION

One aspect includes an audio-visual support and cooling system to maintain A/V equipment at a desired condition. In some embodiments, the system comprises a housing unit configured to support at least one unit of A/V equipment. The housing unit, in some embodiments, comprises a refrigerant inlet, a refrigerant outlet, and a plurality of structural elements configured to define a configuration of the housing, wherein at least one structural element of the plurality of structural elements includes a refrigerant path configured to direct a refrigerant through the at least one structural element between the refrigerant inlet and the refrigerant outlet.

In some embodiments, the at least one structural element includes at least one of a wall of the housing unit, a ceiling of the housing unit, a flooring of the housing unit, a shelf of the housing unit, and a door of the housing unit. In some embodiments, the plurality of structural elements include a ceiling and a flooring, and wherein the ceiling includes at least one air outlet, and the flooring includes at least one air inlet. In some embodiments, the system further comprises at least one support configured to support the at least one unit of A/V equipment within the housing unit.

In some embodiments, at least a portion of the plurality of structural elements are arranged to form an enclosure into which the at least one unit of audio-visual equipment may be disposed. In some embodiments, the refrigerant path includes at least one refrigerant directing element configured such that when the refrigerant flows through the refrigerant path, an air flow within the housing unit causes heat to be transferred away from audio-visual equipment operating within the housing unit through convection. In some embodiments, the air flow includes a flow of air between a first vent in a flooring of the housing unit and a second vent in a ceiling of the housing unit.

Some embodiments further comprise at least one heat exchanger disposed outside of the housing unit and configured to cool the refrigerant, supply the cooled refrigerant to the refrigerant inlet for use in the refrigerant path, and to accept heated refrigerant from the refrigerant outlet for recooling. Some embodiments further comprise a supply pathway configured to couple the refrigerant inlet to the at least one heat exchanger, and an return pathway configured to couple the refrigerant outlet to the at least one heat exchanger. In some embodiments the supply pathway and the return pathway traverse at least one insulator disposed between the housing unit and the heat exchanger. Some embodiments further comprise at least one power distribution element configured to supply power to the at least one unit of audio-visual equipment. In some embodiments, the power distribution element is configured to measure the power supplied to the at least one unit of audio-visual equipment.

Some embodiments further comprise at least one control system configured to operate the audio-visual cooling system. In some embodiments, the control system is configured to receive at least one first indication that the at least one unit of audio-visual equipment is in operation and to operate a heat exchanger to supply the refrigerant. In some embodiments, the at least one indication includes at least one of an indication of a temperature of air within the housing unit and an indication of a power consumption within the housing unit. In some embodiments, the control system is configured to receive at least one second indication that the at least one unit of audio-visual equipment is no longer in operation and to operate the heat exchanger to stop supplying the refrigerant. In some embodiments, the control system is further configured to determine if the audio-visual cooling system is configured to provide sufficient cooling for the at least one unit of audio-visual equipment operating within the housing unit.

In some embodiments, to determine if the audio-visual cooling system is configured to provide sufficient cooling for the at least one unit of audio-visual equipment, the control system is configured to receive an indication of a maximum safe air temperature, receive an indication of an operating power of the audio-visual equipment, determine an expected air temperature within the housing unit based on the operating power, and compare the expected air temperature with the maximum safe air temperature. In some embodiments, the control system is configured to at least one of raise an alarm, reduce the operating power, and shut down the at least one unit of audio-visual equipment when the expected air temperature exceeds the maximum safe air temperature. In some embodiments, to determine the expected air temperature within the housing unit based on the operating power, the control system is configured to account for heat transfer by at least one of leakage, convection, and radiation.

Some embodiments further comprise at least one sensor configured to measure at least one condition of the audio-visual cooling system. In some embodiments, the at least one condition includes at least one of a temperature, a humidity, a pressure, and a power consumption. In some embodiments, the refrigerant path includes at least one of a tube disposed between plates of the at least one structural element and a opening through the at least one structural element.

Another aspect includes a method of cooling audio-visual equipment. In some embodiments, the method comprises controlling a heat exchanger to provide a flow of refrigerant to an inlet of an audio-visual housing unit configured to support at least one unit of audio-visual equipment, directing the flow of the refrigerant from the inlet through a refrigerant path of at least one structural element of the audio-visual housing unit to an outlet of the audio-visual housing unit, and returning the flow of the refrigerant from the outlet to the heat exchanger.

Some embodiments further comprise receiving an indication that the at least one unit of audio-visual equipment is in operation, and wherein controlling the heat exchanger to provide the flow of refrigerant to the inlet of the audio-visual housing unit includes controlling the heat exchanger to provide the flow of refrigerant to the inlet of the audio-visual housing unit in response to receiving the indication. In some embodiments, the indication includes at least one of an indication of a temperature of air within the housing unit and a power consumption by the at least one unit of audio-visual equipment. Some embodiments further comprise measuring the at least one of the temperature and the power consumption. In some embodiments, the at least one structural element includes at least one of a wall of the housing unit, a ceiling of the housing unit, a flooring of the housing unit, a shelf of the housing unit, and a door of the housing unit.

Some embodiments further comprise generating at least one air flow between a lower vent of the housing unit and an upper vent of the housing unit. In some embodiments, directing the flow of the refrigerant from the inlet through the refrigerant path cools air within the housing unit by heat transfer between the refrigerant and the air. Some embodiments further comprise determining if the housing unit is configured to provide sufficient cooling for the at least one unit of audio-visual equipment. In some embodiments, determining if the housing unit is configured to provide sufficient cooling includes receiving an indication of a maximum safe air temperature, receiving an indication of an operating power of the audio-visual equipment, determining an expected air temperature within the housing unit based on the operating power, and comparing the expected air temperature with the maximum safe air temperature.

Some embodiments further comprise at least one of raising an alarm, reducing the operating power, and shutting down the at least one unit of audio-visual equipment when the expected air temperature exceeds the maximum safe air temperature. In some embodiments, determining the expected air temperature within the housing unit based on the operating power includes accounting for heat transfer by at least one of leakage, convection, and radiation. Some embodiments further comprise measuring at least one condition related to the housing unit. In some embodiments the at least one condition includes at least one of a temperature, a humidity, a pressure, and a power input. Some embodiments further comprise receiving at least one indication that the at least one unit of audio-visual equipment is not operating, and controlling the heat exchanger to stop providing the flow of refrigerant in response to receiving the at least one indication. In some embodiments, the at least on indication includes at least one of an indication of a temperature of air within the housing unit and an indication of a power consumption by the audio-visual equipment.

Yet another aspect includes an audio-visual cooling system. The system comprises a refrigerant inlet, a refrigerant outlet, and a plurality of structural elements configured to define an arrangement of a housing unit, wherein at least one structural element of the plurality of structural elements includes a means for directing a refrigerant through the at least one structural element between the refrigerant inlet and the refrigerant outlet such that when the refrigerant flows, an air flow within the housing unit may be generated so that heat is transferred away from audio-visual equipment operating within the housing unit through convection.

In some embodiments, the at least one structural element includes at least one of a wall of the housing unit, a ceiling of the housing unit, a flooring of the housing unit, a shelf of the housing unit, and a door of the housing unit. Some embodiments further comprise at least one heat exchanger disposed outside of the housing unit and configured to cool the refrigerant, supply the cooled refrigerant to the refrigerant inlet for use in the refrigerant path, and to accept the used refrigerant from the refrigerant outlet for recooling. Some embodiments further comprise at least one control system configured to operate the audio-visual cooling system. In some embodiments, the control system is further configured to determine if the audio-visual cooling system is configured to provide sufficient cooling for audio-visual equipment within the housing unit.

The invention will be more fully understood after a review of the following figures, detailed description and claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a view of a cooling system according to one embodiment;

FIG. 2 is a view of an audio-visual housing unit according to one embodiment;

FIG. 3 is cross sectional view of a portion of a structural element of an audio-visual housing unit according to one embodiment; and

FIG. 4 is a flow chart showing an example process that may be performed according to one embodiment.

### DETAILED DESCRIPTION

Embodiments are not limited in their application to the details of construction and the arrangement of components set forth in the following description or illustrated in the drawings. Embodiments are capable of being practiced or of being carried out in various ways. Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

In one aspect, it is recognized that an A/V cooling system may be arranged to provide quiet and effective cooling for consumer and professional A/V equipment. In some embodiments, the A/V cooling system may use natural convection within an A/V housing unit supplemented with a refrigerant flow through structural elements of the A/V housing unit to cool the A/V equipment. Natural convection, rather than forced convection, may not require fans to create an air flow, but rather may rely on natural convective mechanisms such as temperature differences to generate an air flow. The natural convection may be facilitated, in part, by an air to refrigerant heat exchange involving refrigerant flowing through structural elements of the A/V housing unit and air within the A/V housing unit. The heat reduction caused by convection and other heat transfer methods may result in a substantially noiseless removal of heat from the space in which the A/V equipment is used, thereby reliably cooling the A/V equipment without introduction of a substantial amount of undesired sound into the space.

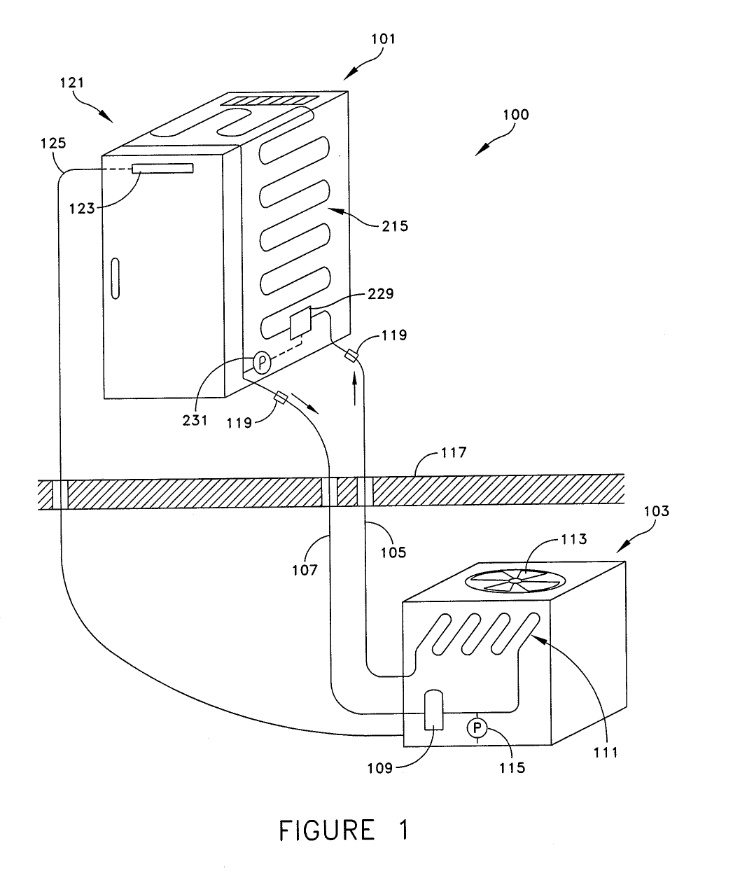

FIG. 1 illustrates an example A/V cooling system 100 according to some embodiments. The A/V cooling system 100 includes an A/V housing unit 101, in which one or more pieces of A/V equipment may be stored; a heat exchanger 103, which may cool a refrigerant supply to the A/V housing unit 101; and an supply path 105 and return path 107, which may carry refrigerant between the A/V housing unit 101 and the heat exchanger 103. In the example embodiment, the refrigerant may include a well known refrigerant such as R134a. It should be recognized that the refrigerant may include any fluid (i.e., liquid and/or gas) that provides desired heat characteristics for a particular implementation.

In operation, the heat exchanger 103 may provide a cooled flow of refrigerant through the supply path 105 to the housing unit 101. The housing unit 101 may use the cooled flow of refrigerant to cool the A/V equipment stored therein, as described in more detail below. The housing unit 101 may return the used refrigerant for recooling through the return path 107 to the heat exchanger 103. The heat exchanger 103 may then recool the used refrigerant and provide it once again to the housing unit 101.

The heat exchanger 103 may include any heat exchanger configured to accept a flow of heated gaseous refrigerant, cool and condense the heated refrigerant, and supply a flow of cooled liquid refrigerant. Such heat exchangers are well known in the art. In one example implementation, the heat exchanger 103 may include a pump or compressor 109 configured to force the refrigerant through a coil arrangement 111. The heat exchanger unit 103 may also include a fan 113 configured to generate an air flow over the coil arrangement 111. The air flow over the coil arrangement 111 may cool and condense the refrigerant pumped through the coil arrangement 111 so that when the refrigerant exits the coil arrangement 111 and is supplied by the heat exchanger 103, it is at a temperature and state sufficient for use by the housing unit 101 to cool the A/V equipment.

In some implementations, the heat exchanger 103 may include a pressure sensor 115. The pressure sensor may measure a pressure of the refrigerant within the heat exchanger 103. The pressure sensor 115 may communicate such a measured pressure to the fan 113 and/or a controller of the cooling system which is described in more detail below. The fan 113 may then adjust itself or be adjusted by the controller so that the pressure reaches a desired level.

The fan 113 and/or the pump or compressor 109 may be controlled to maintain a desired pressure of the refrigerant within the heat exchanger 103 as measured by the pressure sensor 115. The pressure may be chosen based upon the type of refrigerant used. In some implementations in which a phase change refrigerant such as R134a is used, the pressure may be such that the refrigerant changes to a liquid phase when cooled by the air as it flows through the heat exchanger 103. The controller, which is discussed in more detail below, may determine such a desired pressure and control the heat exchanger 103 to operate accordingly. In some implementations in which the refrigerant R134a is used, the pressure may be about 200 psig (e.g., in outdoor settings between about negative twenty and about 130 degrees Fahrenheit).

In some embodiments, the heat exchanger 103 may be disposed separately from the housing unit 101. As illustrated, the heat exchanger 103 may be separated from the housing unit 101 by a thermal and/or noise insulator 117. The thermal and/or noise insulator 117 may insulate the A/V equipment in the A/V housing unit 101 from sound created by the heat exchanger 103 and from heat expelled from the refrigerant by the heat exchanger 103. In some implementations, the thermal and/or noise insulator 117 may include a wall of a building. For example, the housing unit 101 may be disposed in a room of a building and the heat exchanger 103 may be disposed outside of a building or in a separate room of the building from the housing unit 101.

The supply path 105 and return path 107 may include any desired element capable of transporting the refrigerant between the heat exchanger 103 and the housing unit 101. For example, in some embodiments, each of the supply path 105 and return path 107 may include a tubing disposed to traverse the insulator 117. In some implementations, the tubing may include a copper tubing. In some embodiments, at least one end of each of the supply path and return path may include a fitting element, each indicated at 119. The fitting elements 119 may be configured to allow easy coupling to the housing unit 101. The fitting elements may include any desirable detachable fitting, as is well known in the art.

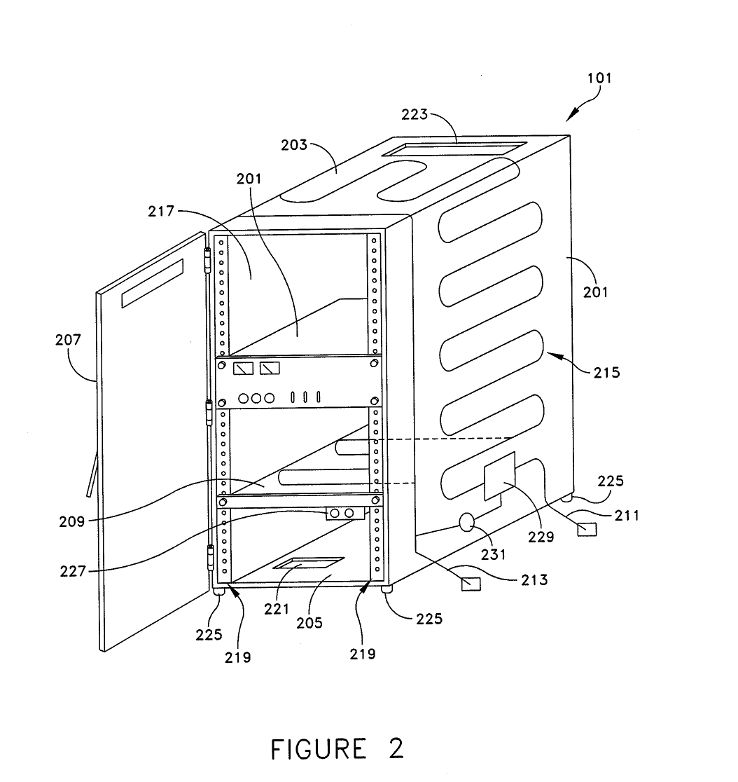

A more detailed view of the housing unit 101 is illustrated in FIG. 2. The housing unit 101 may include a plurality of structural elements such as side walls 201, a ceiling 203, a flooring 205, one or more doors 207, and/or one or more shelves 209 that define an arrangement of the housing unit 101 and are discussed in more detail below.

The housing unit 101 may include a supply 211 and a return 213. The supply and return may each include fitting elements configured to detachably couple the supply 211 and return 213 to the supply path 105 and return path 107, respectively (e.g., to corresponding fittings elements 119). Such coupling may allow refrigerant to flow from the supply path 105 into the housing unit 101 and from the housing unit 101 into the return path 107.

The housing unit 101 may include a refrigerant path 215 that is defined by one or more of the structural elements such that refrigerant flows from the supply 211 to the return 213 while cooling air within the housing unit 101. One or more pieces of A/V equipment 217 may be housed within the housing unit 101 so that during operation, the heat produced by the A/V equipment 217 is removed from the housing unit 101, in part, by the flow of refrigerant along the refrigerant path 215. The refrigerant path and structural elements are described in more detail below.

In some embodiments, the housing unit 101 may include a plurality of attachment points, generally indicated at 219. The attachment points 219 may include, for example, fastener, screw, or tab holes, along one or more surfaces of opposite parallel walls 201, as illustrated in FIG. 2. In some implementations, such attachment points 219 may be disposed on both a front and rear of the housing unit 101 so that they are accessible through a front door (e.g., 207 shown in FIG. 2) and a rear door (not shown). Such attachment points 219 may allow attachment of the A/V equipment 217 if the A/V equipment 217 is configured with matching attachment points such as a front and/or rear face plate that includes corresponding fastener, screw, or tab holes through which a fastener, screw, or tab may attach the A/V equipment 217 to the housing unit 101.

The attachment points 219 may additionally or alternatively allow for attachment of one or more shelves 209. Such shelves 209, similar to the described example A/V equipment 217 may include a face plate or other attachment portion that match the attachment points 219, such as fastener or screw holes, and that allow the shelves to be attached at locations to accommodate the A/V equipment 217.

In some implementations, tabs may be coupled to shelves 209 and/or A/V equipment 217 for attachment with a tab and hole based attachment system. In some implementations, additional or alternative attachment mechanisms may be used, such as attachment points within an inner surface of one or more structural elements, or any other desired attachment mechanism.

Some embodiments of the housing unit 101 may include one or more vents 221, 223. As illustrated in FIG. 2, an air inlet vent 221 may be disposed in the flooring 205 of the housing unit 101. The air inlet vent 221 may allow air from below the housing unit 101 to enter the interior of the housing unit 101. Since cooler air is generally denser than warmer air, air below the housing unit 101 may generally be cooler than air elsewhere around the housing unit 101. To help facilitate such air flow, the housing unit 101 may include one or more support elements 225 to elevate the flooring 205 above a ground of a room in which the housing unit 101 is disposed. The support elements 225 may include wheels, legs, casters, and/or any other desired type of support elements. Also as illustrated in FIG. 2, an air exhaust vent 223 may be disposed in the ceiling 203 of the housing unit 101. The air exhaust vent 223 may allow air from within the housing unit 101 to escape the housing unit 101. Since warmer air is generally less dense than cooler air, the warmest air inside the housing unit may rise to the top of the housing unit 101 and escape out the exhaust vent 223. It should be understood that the positioning and dimensions of the vents 221, 223 are given as examples only, and that other embodiments may include alternative locations, numbers, and dimensions of vents or no vents at all.

Some embodiments of housing unit 101 may include one or more power distribution elements 227. The power distribution element 227 may be configured to supply power to the A/V equipment 217 within the housing unit 101. The power distribution element 227 may include, for example, an S-type universal power supply available from American Power Conversion, Corp., West Kingston, R.I. The power distribution element 227 may include a power consumption sensor (not shown), which are well known in the art, configured to monitor an amount of power consumed by the A/V equipment 217 within the housing unit. Such information may be communicated to a controller associated with the cooling system, which is described in more detail below.

In some embodiments, the housing unit may include a wiring element (not shown). Such a wiring element may include, for example, an opening in a rear of the housing unit through which wiring may be disposed. The wiring, may include, for example, cables connecting the A/V equipment within the housing unit to A/V equipment outside of the housing unit, such as speakers, displays, etc.

As mentioned above, the housing unit may include a plurality of structural elements such as walls 201, ceilings 203, floorings 205, doors 207, and/or shelves 209. The structural elements may define an arrangement of the housing unit 101. As illustrated in FIG. 2, in one embodiment, such an arrangement may include an enclosure into which A/V equipment may be placed. The housing unit 101 may include two side walls 201, a ceiling 203, a flooring 205, a front door 207 and a back door (not shown). Although some embodiments may include only a single door, including a front and back door may be desirable for equipment that is controllable from a front side and requires wiring or other setup from a back side, such as typical A/V equipment. The arrangement may also include one or more shelves 209 that may be movable to allow custom arrangements to accommodate the A/V equipment 217 or permanently positioned to a default arrangement. In some implementations, the structural elements may be made from one or more metals, such as aluminum, that have a relatively high radiation emissivity to increase heat transfer through radiation, which is described below.

In some embodiments, a size of the housing unit 101 may be selected such that the A/V equipment 217 may fit within the housing unit 101. The size may be wider and/or longer than the A/V equipment 217 so that cables and/or other accessories may also fit within the housing unit 101. In some implementations, the housing unit 101 may be large enough so that the shelf 209 and/or the A/V equipment 217, cables and accessories within the housing unit 101 do not fill all of a vertical axis of the housing unit 101, thereby leaving room through which air may move through the housing unit 101 from a bottom vent 221 to a top vent 223.

As mentioned above, at least one of the structural elements may include the refrigerant path 215. The refrigerant path 215 may include a fluid directing element through which the refrigerant may flow from the supply 211 (i.e., inlet) to the return 215 (i.e., outlet). The fluid directing element may include, for example, a tubing (e.g., a copper tubing) disposed within the structural element. In FIG. 2, the two side walls 201, the ceiling 203, and the shelf 209 define the refrigerant path 215. Refrigerant supplied from the heat exchanger 103 to the supply 211, as described above, may flow along the refrigerant path 215 to the return 213 exchanging heat with air inside the housing unit 101, thereby cooling the A/V equipment 217 which operates inside the housing unit 101, as is described in more detail below. The refrigerant may then flow back to the heat exchanger 103 for recooling through the return 213 forming a closed loop between the heat exchanger 103 and the housing unit 101.

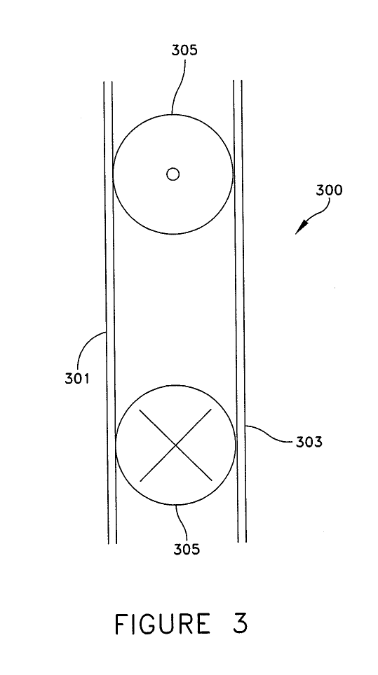

FIG. 3 illustrates a cross sectional view of a portion of a structural element 300 of the housing unit 101. As illustrated, the structural element 300 may include a first element 301, a second element 303, and fluid directing elements 305. In some embodiments, the first element 301 may be a top element of a shelf or an inner element of a wall, ceiling, flooring or door. In some embodiments, the second element 303 may include a bottom element of a shelf or an outer element of a wall, ceiling, flooring, or door.

In some implementations, each of the first element 301 and the second element 303 may include a metal or other plate forming a space there between in which the fluid directing elements 305 may be disposed. In such an implementation, the fluid directing elements 305 may include one or more tubings disposed between the first element 301 and the second element 303. Such tubing may be affixed to one or more elements with adhesive, brackets, and/or any other mechanism. In other implementations, the first element 301 and the second element 303 may include opposing surfaces of a single metal or other material plate. In such an implementation, the fluid directing elements may include a channel or other hole through the structural element 300. For example, the fluid directing elements 305 may include channels stamped or otherwise cut into a metal or other material plate.

Referring again to FIG. 2, the refrigerant path 215 may be configured in any arrangement such as one in which the refrigerant flows from the supply 211 to the outlet 215 through one or more structural elements of the housing unit 101. In one implementation, the refrigerant path 215 may include a zigzagging pattern from front to back of the housing unit 101. The refrigerant path may be arranged so that refrigerant flows up one wall, along the ceiling 203 and down the other wall, as illustrated in FIG. 2. The refrigerant path 215 may be arranged so that refrigerant flows to the return 213 by a return portion of the refrigerant path 215 traversing back up the second wall across the ceiling 203 and down the first wall to the return 213. In other implementations, the return 213 and the supply 211 may be disposed on different sides of the housing unit 101 so that such a return portion may not be used.

In some embodiments, the refrigerant path 215 may include a plurality of subpaths. Each subpath may direct a portion of a refrigerant flow at least a part of the way from the supply 211 to the return 213. For example, in the embodiment of FIG. 2, the refrigerant path 215 includes two subpaths, one as described above along the walls 201 and ceiling 203 of the housing unit 101, and a second along the shelf 209.

To facilitate such subpaths, the shelf 209 may connect to one or more of the walls 201 of the housing unit 101 with one or more refrigerant path taps allowing access to the refrigerant path 215. In some embodiments in which the shelf 209 is permanently positioned, such taps may produce a permanent connection between the subpath of the shelf 209 and the rest of the refrigerant path 215. The tap may include, for example, a tubing, such as a copper or rubber tubing configured to connect to the rest of the refrigerant path 215. In some embodiments in which the shelf 209 is movable from one location to another to create a custom arrangement, the taps may produce a temporary connection between the subpath of the shelf 209 and the rest of the refrigerant path 215. Such taps may allow the subpath of the shelf to be connected to the rest of the refrigerant path 215 at desired locations within the housing unit 101 (e.g., locations corresponding to attachment points 219).

In some embodiments, housing unit 101 may include a plurality of shelves that are substantially similar to shelf 209. Each shelf may include a refrigerant subpath through which refrigerant may flow during operation of the A/V equipment 217 and may be coupled to the housing unit 101 with respective refrigerant taps. In some implementations, to improve heat dissipation away from pieces of A/V equipment, the shelves may be arranged such that pieces of A/V equipment are separated by one or more shelves. In some implementations, for particularly high heat producing A/V equipment, one such shelf may be disposed below the high heat A/V equipment and one such shelf may be disposed above the high heat A/V equipment allowing heat dissipation into both shelves away from the high heat A/V equipment.

In some embodiments, an expansion valve 229 or other flow regulator may be disposed along the refrigerant path 215. The expansion valve 229 may generally separate a high pressure refrigerant at or near the supply 211 supplied from the heat exchanger 103 from a low pressure refrigerant in a majority of the refrigerant path 215 and the return path 107 returning to the heat exchanger 103.

The expansion valve 229 may be configured to control pressure of refrigerant within the refrigerant path 215 so that pressure of the refrigerant is at a level at which the refrigerant may boil during operation of the A/V equipment 217. For example, for R134a, the refrigerant may be maintained below a pressure of about 180 psig if the temperature in the housing is between about 90 and about 120 degrees Fahrenheit corresponding to the boiling point of R134a at that pressure. This allows refrigerant to boil, thereby absorbing heat at a rate proportional to the product of refrigerant mass flow rate and specific heat of vaporization of the refrigerant. It should be recognized that this pressure, temperature and refrigerant are given as a non-limiting example only. In some implementations, temperature within the housing unit may be measured by one or more sensors, and the expansion valve 229 may be adjusted accordingly (e.g., by one or more controllers) so that pressure within the refrigerant path 215 is at a level at which the refrigerant may boil. Such a pressure value may be a known value based on a refrigerant type and temperature and may be obtainable from a lookup table or other stored value or determined in any other way, by a controller, which is described in more detail below.

In some embodiments, housing unit 101 may include a pressure sensor 231. The pressure sensor may measure pressure of refrigerant in the refrigerant path 215. Such a measurement may be used, for example to determine if the expansion valve 229 is providing adequate pressure of refrigerant and to adjust the expansion valve 229 to increase or decrease pressure accordingly.

Referring again to FIG. 1, the cooling system 100 may include a control system 121 configured to control the one or more components to facilitate refrigerant flow through the refrigerant path 215 during operation. The control system may include a controller 123 and control network 125 that couples the housing unit to the heat exchanger (e.g., through the insulator 117). The control network 125 may include a wired network as illustrated in FIG. 1 and/or a wireless network such as a WiFi network. In one embodiment, the controller 123 may include a Philips XAG49 microprocessor, available commercially from the Phillips Electronics Corporation North America, New York, N.Y. Because A/V equipment may involve intermittent usage and varying load levels, the control system 121 may save energy by limiting operation of the cooling system 100 to correspond to operation of the A/V equipment and operating the cooling system 100 to provide sufficient cooling, for example, by controlling pressure within the refrigerant path 215 and/or the heat exchanger 103.

The control system may also include one or more input devices (not shown), such as a keyboard, slider, etc., or through a master controller provided for the room. Through such an input device, a user may enter one or more cooling parameters. Such cooling parameters may include for example a cooling set point, above which the cooling system 100 may be configured to operate to cool the housing unit, and below which the cooling system 100 may be configured not to operate to cool the housing unit 101. Another such cooling parameters may include a maximum temperature, which may indicate a temperature above which the A/V equipment may be affected adversely by heat. In some implementations, if a user does not enter such values, default values may be used. In some implementation such a maximum temperature may include 109 degrees Fahrenheit, and such a cooling set point may include eighty degrees Fahrenheit.

In some embodiments, to facilitate control of the cooling system, as mentioned above, one or more sensors may be disposed in or around the cooling system. For example, pressure sensors 115 and 231 may be disposed to measure refrigerant pressure. Temperature sensors (not shown) may be disposed within the housing unit 101 to measure temperature of air within the housing unit 101. In some implementations, temperature sensors may be disposed outside of the housing unit 101, within structural elements of the housing unit, in A/V equipment and/or in any other desired location. Such sensors may report measured conditions to the control system 121 (e.g., to the controller 123 over the control network 125).

In some implementations, the second pressure sensor 231 may also monitor a suction pressure in the supply line 107. This information may be transmitted to the controller and used to vary parameters of the cooling system 100 (e.g., control an amount of refrigerant drawn through the housing unit 101 by an expansion valve 231 or other regulator) to protect the pump or compressor 109 in the event of an overload condition. The use of pressure sensors in this manner is well known in the art and used with a variety of heat exchangers such as those used in typical home cooling systems.

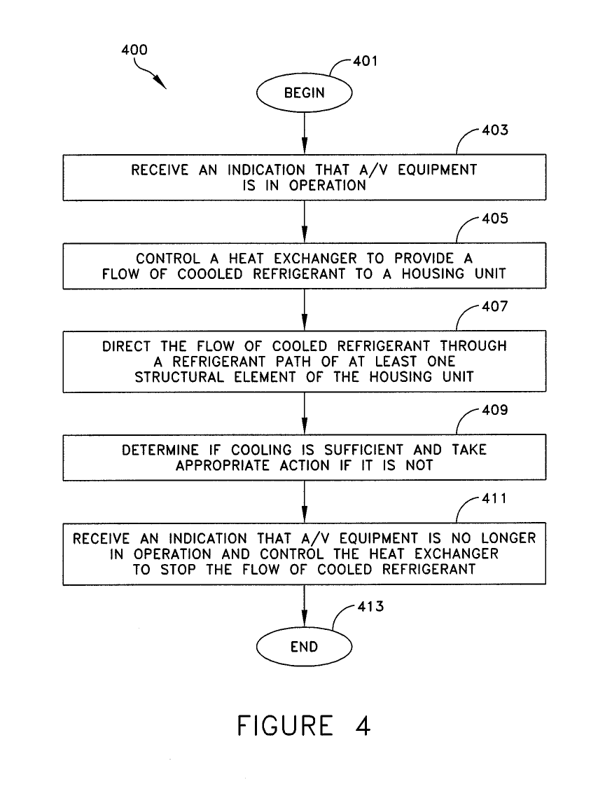

FIG. 4 illustrates an example process that may be performed by some embodiments (e.g., by the cooling system 100). It should be recognized that process 400 is given as an example only and that other processes having alternative and/or additional parts may be performed in other embodiments. Process 400 may begin at block 401.

As indicated at block 403, process 400 may include receiving an indication that A/V equipment is in operation. The indication may include input from the one or more sensors, such as temperature sensors measuring the temperature of air within the housing unit 101, input from the A/V equipment, input from a user, input from the power distribution element, 227 and/or any other desired type of indication from any other source. In some implementations, the indication may include an indication that the temperature within the housing unit 101 has reached a set point or is approaching the set point, or that power is being drawn from the power distribution element 227.

As indicated at block 405, process 400 may include controlling the heat exchanger 103 to provide a flow of cooled refrigerant to the housing unit 101. Controlling the heat exchanger 103 may include transmitting control signals to the heat exchanger 103 (e.g., from the controller 123 over the control network 125) to operate the flow regulator 109. Based upon input from one or more input devices and one or more sensors, as described above, the control system 121 may adjust control of the cooling system 100 to provide desired cooling of the A/V equipment. For example, the control system 121 may adjust the expansion valve 229 of the housing unit 101 so that pressure of refrigerant within the refrigerant path 215 is low enough so that refrigerant will boil at a temperature near the temperature measured by the one or more temperature sensors. The control system 121 may determine such an adjustment by reference to one or more lookup tables or other stored values indicating a position of the expansion valve based on temperatures measured by one or more sensors. Such stored values may be determined prior to installation of the cooling system and stored, for example, on one or more machine readable media. In some implementations, the control system 121 may also adjust the heat exchanger 103 to operate at a level that corresponds with the desired total pressure to allow the refrigerant to cool in the heat exchanger 103, for example, by adjusting the flow regulator 109, as described above.

As indicated at block 407, process 400 may include directing the flow of cooled refrigerant through the refrigerant path 215. After the heat exchanger 103 provides the flow of cooled refrigerant to the supply 211 and the expansion valve 229 allows a portion into the refrigerant path 215 to maintaining the desired pressure in the refrigerant path 215, as discussed above, the refrigerant may be directed through the refrigerant path 215 to cool the air within the housing unit 101. Once the air is cooled by the refrigerant, the refrigerant may be returned through the return 213 to be recooled by the heat exchanger 103.

In operation, the A/V equipment 217 may heat air within the housing unit 101. The heated air may establish a natural convective air current whereby hot air moves towards the top of the housing unit 101 and leaks out through the exhaust vent 223, and cooler air is drawn in to replace the exhausted air through the inlet vent 221. Further, the warmed air may transfer heat through the inner elements of structural elements which form part of the refrigerant path 215 removing heat from the air inside the housing unit 101 through conduction. Air cooled in such a way may contribute to the convection air currents within the rack by flowing towards the bottom of the rack allowing the hottest air to escape through the exhaust vent 223.

As indicated at block 409, process 400 may include determining if cooling of the A/V equipment is sufficient and taking appropriate precautionary actions if it is determined not likely to be sufficient. To determine if the housing unit 101 is configured to sufficiently cool A/V equipment operating in the housing unit 101, the control system 121 may calculate an expected internal air temperature at current operating power. Such calculation may be useful, for example, to determine if the housing unit may be able to dissipate heat at least as great as the heat generated by the operation of the A/V equipment at the operating power. In some implementations, the heat generated by the power consumed by the A/V equipment may be measured by a power distribution element 227 of the housing unit 101 or some other device and communicated to the control system 121.

In some implementations, the control system 121 (e.g., controller 123) may account for heat transfer by each of three methods including leakage, convection, and radiation. Leakage may include heat transfer from air flow in and out of the housing unit (e.g., through vents 223 and 221), convection may include heat transfer between warm air within the rack and cool structural elements cooled by the flow of refrigerant through the refrigerant path, and radiation may include heat transfer by thermal radiation from surfaces of the A/V equipment, such as housings and/or heat sinks to inner surfaces of the structural elements of the housing unit 101.

Regarding convection, because A/V equipment may not contain fans as a result of A/V equipment manufacturers' recognition of the importance of noise abatement in such equipment, airflow within the interior of the rack may be largely or entirely resulting from convective activity. Air flowing past the A/V equipment housings and/or heat sinks may absorb heat and become buoyant relative to surrounding cooler air, and similarly air passing along the cooled inner elements of structural elements of the housing unit 101 may surrender heat to the elements and refrigerant path 215, thereby becoming more dense than surrounding air and sinking towards the bottom of the housing unit 101. These convective currents may result in a continuous circulation of air within the housing unit 101 between A/V equipment and the surrounding structural elements and therefore a continuous rate of heat transfer carried out of the housing unit by refrigerant leaving the refrigerant path 215.

Regarding leakage, in some implementations of the housing unit 101, as described above, the housing unit may include one or more vents 223 in the top and one or more vents 221 near the bottom. This configuration may allow some of the hot air from within the housing unit 101 to escape from the housing unit 101 (e.g., through the top vents 223) driven by convective activity within the housing unit 101. The escaping hot air may tend to remain in close proximity to the exterior surface of the housing unit 101, especially if the housing unit 101 is installed in a small space, thereby surrendering some heat energy to the refrigerant path 215 through the exterior surface of the housing unit 101. Such air may then sink towards the floor as it becomes cooler and therefore denser. Such cooler air, and/or other cooler air from a surrounding environment, may be introduced to the interior of the housing unit 101 by way of the lower vent 221. As hot air escapes the top vent 223, a current or vacuum may cause cool air near the lower vent 221 to be drawn into the housing unit 101.

In some implementations, to increase the amount of heat transferred through leakage, one or more fans may be included in the housing unit 101. Such fans may introduce noise caused by the movement of forced air, but may also increase the amount of heat transfer caused by leakage. In some implementations, such fans may be operated if the heat transfer would otherwise not be sufficient to cool the operating A/V equipment.

Regarding radiation, heat is transferred by way of electromagnetic infra-red radiation from hot surfaces of the A/V equipment to cool surfaces of the structural elements. The rate of heat transfer may be proportional to the fourth power of temperature difference between these surfaces, and may also depend upon material properties of the surfaces.

To determine heat dissipation by one or more of the above mechanisms, one or more calculations may be performed. Maximum heat dissipation may be equal to

qₜₒₜ=q₁+q₂ (1)

where q₁ indicates heat output by radiation and heat output by convection, q₂ indicates heat output by leakage, and qₜₒₜ indicates an amount of heat dissipated by the cooling system.

The heat output by radiation and by convection may be defined according to:

q₁=hA₂(Tₐᵢᵣ−T_{w}) (2)

where h indicates a variable estimating a heat transfer coefficient, which is described in more detail below, Tₐᵢᵣ indicates an estimated temperature of the air within the housing unit, T_{w} indicates a temperature of the interior surfaces of the structural elements, which may be measured by one or more sensors, estimates, or determined in any other desired way, and A₂ indicates an internal area of the surfaces of the structural elements, which may be a known value measured before installation of a particular housing unit. In some implementations, T_{w} may be expected to be around about 50 degrees Fahrenheit, and A₂ may be about 50 ft².

The heat output by leakage may be defined according to:

q=\dot{m}Cp(Tₐᵢᵣ−T_{amb}) (3)

where \dot{m} indicates a mass of air exiting the housing unit. This value may be measured by one or more sensors, approximated, measured before installation or determined in some other way. \dot{m} may vary according to size and arrangement of vents 221, 223, and differences of temperature inside the housing unit 101 and outside the housing unit 101. In some implementations, \dot{m} may be estimated based on values measured before installation, such values may range, for example from below about 10 CFM to above about 80 CFM. Cp indicates the specific heat capacity of air, a known value equal to 1005 J/(Kg ° C.), and T_{amb} indicates the temperature of ambient air in the room in which the housing unit is installed. T_{amb} may be measured by one or more sensors, estimated (e.g., as room temperature), or determined in any other way.

Combining equations 1, 2, and 3, an equation defining Tₐᵢᵣ may be developed as:

$${T}_{air} = \frac{{q}_{tot} + \dot{m} {CpT}_{amb} + {A}_{2} {hT}_{w}}{{A}_{2} h + \dot{m} Cp} . \qquad ( 4 )$$

q₁ may be separated into components q_{rad} for heat output by radiation and q_{c} for heat output by convection. q_{rad} may be defined according to:

$${q}_{rad} = \frac{σ ( {T}_{air}^{4} - {T}_{w}^{4} )}{\frac{1 - {ɛ}_{1}}{{ɛ}_{1} {A}_{1}} + \frac{1}{{A}_{1} {F}_{12}} + \frac{1 - {ɛ}_{2}}{{ɛ}_{2} {A}_{2}}} , \qquad ( 5 )$$

where σ indicates the Stephan Boltzmann constant

$$( i . e . , 5.669 \cdot {10}^{- 8} \frac{w}{{m}^{2} {K}^{4}} ) ,$$

Tₐᵢᵣ again indicates an expected temperature of air within the housing unit 101, T_{w} again indicates the temperature of the inner surfaces of the structural elements, ε₁ indicates an emissivity of the A/V equipment, A₁ indicates an area of the outer surface of the A/V equipment, ε₂ indicates an emissivity of the inner surfaces of the structural elements, and F₁₂ indicates a view factor between the inner surfaces of the structural elements and the outer surface of the A/V equipment.

ε₁ may be a known value for a particular material and color used for the surface of the interior structural elements measured prior to installation of the housing unit. ε₂ may differ for each piece of A/V equipment. A reasonable assumption for both ε₁ and ε₂ is that they will both equal about 0.7. A₁ may vary for each piece of electronic equipment and a number of pieces of equipment. A₁ may be input through one or more input devices, such as sliders or keyboards, as described above, estimated, or determined in any other way. In some implementations, A₁ may be about 15 ft². F₁₂ may vary from one configuration to the next. A reasonable assumption however is that F₁₂ may equal about one since the housing unit 101 may surround the entirety of the A/V equipment.

From equation 5 and the reasonable estimates described above, a linearized heat transfer coefficient hᵣ, one part of h described above, may be defined as:

$${h}_{r} = [ \frac{σ}{1.43 ( \frac{{A}_{2}}{{A}_{1}} ) + 0.43} ] ( {T}_{air} + {T}_{w} ) ( {T}_{air}^{2} + {T}_{w}^{2} ) . \qquad ( 6 )$$

It should be recognized that other estimated values or measured values may be used, so that equation 6 may be different in dissimilar implementations and that the example equation 6 is given as a non-limiting example only. Equation 5 may then be simplified to

q_{rad}=hᵣA₂(Tₐᵢᵣ−T_{w}). (7)

Separating h from above to equal hᵣ+h_{c}, where h_{c} indicates the linear heat transfer coefficient for convection for a configuration of the housing unit, which may be determined before installation of the housing unit according to well known methods, and hᵣ indicates the linearized heat transfer coefficient for radiation from above, equation 4 becomes:

$${T}_{air} = \frac{{q}_{tot} + \dot{m} {CpT}_{amb} + {A}_{2} ( {h}_{r} + {h}_{c} ) {T}_{w}}{{A}_{2} ( {h}_{r} + {h}_{c} ) + \dot{m} Cp} . \qquad ( 8 )$$

qₜₒₜ may be set to equal at least as much as a measured value of the power consumed by the A/V equipment inside the housing unit, an amount about equal to the amount of heat being added to the housing unit 101. In various implementations, the power consumed by the A/V equipment may reach levels above 1,000 Watts and in some implementations may reach as high as several thousand Watts. Then, knowing each of the variables or estimates therefore for qₜₒₜ, \dot{m}, Cp, T_{amb}, A₁, A₂, h_{c}, T_{w}, and σ, as described above, equations 6 and 8 may be solved together for the two unknown variables hᵣ and Tₐᵢᵣ according to any desired mathematical method as is well known in the art. In one implementation, the equations may be transformed into

$$\begin{matrix}{X}_{1} = {T}_{air} - \frac{{q}_{equip} + \dot{m} {CpT}_{amb} + {A}_{2} ( {h}_{r} + {h}_{c} ) {T}_{w}}{{A}_{2} ( {h}_{r} + {h}_{c} ) + \dot{m} Cp} and & ( 9 ) \\ {X}_{2} = {h}_{r} - [ \frac{σ ( {T}_{air} + {T}_{w} ) ( {T}_{ail}^{2} + {T}_{w}^{2} )}{1.43 ( \frac{{A}_{2}}{{A}_{1}} ) + 0.43} ] , & ( 10 )\end{matrix}$$

respectively. Values of hᵣ and Tₐᵢᵣ may then be varied until X₁²+X₂² equals about zero. X₁ and X₂ indicate an error factor and the limitation that X₁²+X₂² equals about zero is a limitation on an acceptable amount of error. Other methods of limiting error and determining hᵣ and/or Tₐᵢᵣ may be used.

Once Tₐᵢᵣ is determined, the determined value may be compared to the maximum temperature value (e.g., a value described above). In some implementations, such a value may be about 109 degrees Fahrenheit. If the expected Tₐᵢᵣ value is greater than the maximum value, the housing unit 101 may not be able to sufficiently cool the A/V equipment operating at the current level and a precautionary action may be taken. Such actions may include limiting power input, shutting down the one or more pieces of A/V equipment, raising an alarm, and/or any other desired action.

In some implementations, it may be desirable to determine a fraction of heat output by each of the three heat transfer methods described above. Such fractions may be determined according to:

$$\begin{matrix}{f}_{leakage} = \frac{\dot{m} Cp ( {T}_{air} - {T}_{amb} )}{{q}_{tot}} & ( 11 ) \\ {f}_{convection} = \frac{{h}_{c} {A}_{w} ( {T}_{air} - {T}_{w} )}{{q}_{tot}} and & ( 12 ) \\ {f}_{radiation} = \frac{{h}_{r} {A}_{w} ( {T}_{air} - {T}_{w} )}{{q}_{tot}} & ( 13 )\end{matrix}$$

where f_{leakage} indicates a fraction output by leakage, f_{convection} indicates a fraction output by convection and f_{radiation} indicates a fraction output by radiation. In some implementations, such information may be provided to a user (e.g., an administrator, operator, installer, designer, etc.) through a display, communication network, or any other method.

Although not indicated in FIG. 4, some embodiments of process 400 may include determining if condensation is likely to form on a surface of the housing unit. In some embodiments, the control system may be configured to prevent condensation on the housing unit. For example, based on measured temperature of the air outside and/or inside of the housing unit (e.g., measure by one or more sensor) the control system may determine a corresponding dew point for the housing unit (e.g., according to well-known methods of dew point calculation or lookup methods including measuring humidity or assuming a conservative humidity level).

In some situations, heat generated by operation of the A/V equipment would increase the temperature to a level where a refrigerant flow through the refrigerant path 215 would reduce the temperature of the structural elements to a point at which condensation may form. In some implementations, the control system may prevent such a situation from occurring. For example, a situation may be prevented by limiting refrigerant flow through the refrigerant path 215 (e.g., adjusting expansion valve 229 and/or the heat exchanger 103), raising an alarm, and/or taking any other desired action (e.g., shutting down the A/V equipment, etc.). Such action may occur if the structural element temperature reaches or is expected to reach within a margin (e.g., three degrees Celsius) of a dew point temperature. In response to an alarm, a user may lower room humidity or decreasing the heat load imposed by operating A/V equipment to continue operation of the A/V equipment.

As indicated at block 411, process 400 may include receiving an indication that A/V equipment is no longer in operation and controlling the heat exchanger 103 to stop the flow of refrigerant accordingly. For example, an indication may be received by the control system 121 that the air temperature within the housing unit 101 is below the set point or that power is no longer being drawn from the power distribution element 227, the control system 121 may operate to stop the heat exchanger 103. The set point may correspond, in some implementations, to a point below which the heat exchanger cannot operate to generate a low enough pressure or below which the expansion valve 229 cannot provide a low enough pressure to allow the refrigerant to boil within the refrigerant path 215. In response, the control system may control the heat exchanger to stop operation (e.g., by transmitting a control single to the heat exchanger 103 to stop a flow regulator 109). Stopping the flow of refrigerant from the heat exchanger may cause the refrigerant in the refrigerant path 215, return path, 107, supply path 105, and heat exchanger 103 to lose pressure and stop flowing until the heat exchanger 103 begins operation again.

It should be recognized that while embodiments are described with respect to A/V equipment, other types of electronic equipment or other objects may also be cooled by some embodiments in addition to or as an alternative to A/V equipment. Further, it should be recognized that the housing unit 101 may take any desired form in any desired shape.

Having thus described several aspects of at least one embodiment, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. An audio-visual support and cooling system to maintain A/V equipment at a desired condition, comprising:
a housing unit configured to support at least one unit of A/V equipment, including:
a refrigerant inlet,
a refrigerant outlet, and
a plurality of structural elements configured to define a configuration of the housing, wherein at least one structural element of the plurality of structural elements includes a refrigerant path configured to direct a refrigerant through the at least one structural element between the refrigerant inlet and the refrigerant outlet.

2. The system of claim 1, wherein the at least one structural element includes at least one of a wall of the housing unit, a ceiling of the housing unit, a flooring of the housing unit, a shelf of the housing unit, and a door of the housing unit.

3. The system of claim 1, wherein the plurality of structural elements include a ceiling and a flooring, and wherein the ceiling includes at least one air outlet, and the flooring includes at least one air inlet.

4. The system of claim 1, further comprising at least one support configured to support the at least one unit of A/V equipment within the housing unit.

5. The system of claim 1, wherein at least a portion of the plurality of structural elements are arranged to form an enclosure into which the at least one unit of audio-visual equipment may be disposed.

6. The system of claim 1, wherein the refrigerant path includes at least one refrigerant directing element configured such that when the refrigerant flows through the refrigerant path, an air flow within the housing unit causes heat to be transferred away from audio-visual equipment operating within the housing unit through convection.

7. The system of claim 6, wherein the air flow includes a flow of air between a first vent in a flooring of the housing unit and a second vent in a ceiling of the housing unit.

8. The system of claim 1, further comprising at least one heat exchanger disposed outside of the housing unit and configured to cool the refrigerant, supply the cooled refrigerant to the refrigerant inlet for use in the refrigerant path, and to accept heated refrigerant from the refrigerant outlet for recooling.

9. The system of claim 8, further comprising an supply pathway configured to couple the refrigerant inlet to the at least one heat exchanger, and an return pathway configured to couple the refrigerant outlet to the at least one heat exchanger.

10. The system of claim 9, wherein the supply pathway and the return pathway traverse at least one insulator disposed between the housing unit and the heat exchanger.

11. The system of claim 1, further comprising at least one power distribution element configured to supply power to the at least one unit of audio-visual equipment.

12. The system of claim 11, wherein the power distribution element is configured to measure the power supplied to the at least one unit of audio-visual equipment.

13. The system of claim 1, further comprising at least one control system configured to operate the audio-visual cooling system.

14. The system of claim 13, wherein the control system is configured to receive at least one first indication that the at least one unit of audio-visual equipment is in operation and to operate a heat exchanger to supply the refrigerant.

15. The system of claim 14, wherein the at least one indication includes at least one of an indication of a temperature of air within the housing unit and an indication of a power consumption within the housing unit.

16. The system of claim 14, wherein the control system is configured to receive at least one second indication that the at least one unit of audio-visual equipment is no longer in operation and to operate the heat exchanger to stop supplying the refrigerant.

17. The system of claim 13, wherein the control system is further configured to determine if the audio-visual cooling system is configured to provide sufficient cooling for the at least one unit of audio-visual equipment operating within the housing unit.

18. The system of claim 17, wherein to determine if the audio-visual cooling system is configured to provide sufficient cooling for the at least one unit of audio-visual equipment, the control system is configured to:
receive an indication of a maximum safe air temperature;
receive an indication of an operating power of the audio-visual equipment;
determine an expected air temperature within the housing unit based on the operating power; and
compare the expected air temperature with the maximum safe air temperature.

19. The system of claim 18, wherein the control system is configured to at least one of raise an alarm, reduce the operating power, and shut down the at least one unit of audio-visual equipment when the expected air temperature exceeds the maximum safe air temperature.

20. The system of claim 18, wherein to determine the expected air temperature within the housing unit based on the operating power, the control system is configured to account for heat transfer by at least one of leakage, convection, and radiation.

21. The system of claim 1, further comprising at least one sensor configured to measure at least one condition of the audio-visual cooling system.

22. The system of claim 21, wherein the at least one condition includes at least one of a temperature, a humidity, a pressure, and a power consumption.

23. The system of claim 1, wherein the refrigerant path includes at least one of a tube disposed between plates of the at least one structural element and a opening through the at least one structural element.

24. A method of cooling audio-visual equipment, the method comprising:
controlling a heat exchanger to provide a flow of refrigerant to an inlet of an audio-visual housing unit configured to support at least one unit of audio-visual equipment;
directing the flow of the refrigerant from the inlet through a refrigerant path of at least one structural element of the audio-visual housing unit to an outlet of the audio-visual housing unit; and
returning the flow of the refrigerant from the outlet to the heat exchanger.

25. The method of claim 24, further comprising receiving an indication that the at least one unit of audio-visual equipment is in operation, and wherein controlling the heat exchanger to provide the flow of refrigerant to the inlet of the audio-visual housing unit includes controlling the heat exchanger to provide the flow of refrigerant to the inlet of the audio-visual housing unit in response to receiving the indication.

26. The method of claim 25, wherein the indication includes at least one of an indication of a temperature of air within the housing unit and a power consumption by the at least one unit of audio-visual equipment.

27. The method of claim 26, further comprising measuring the at least one of the temperature and the power consumption.

28. The method of claim 24, wherein the at least one structural element includes at least one of a wall of the housing unit, a ceiling of the housing unit, a flooring of the housing unit, a shelf of the housing unit, and a door of the housing unit.

29. The method of claim 24, comprising generating at least one air flow between a lower vent of the housing unit and an upper vent of the housing unit.

30. The method of claim 24, wherein directing the flow of the refrigerant from the inlet through the refrigerant path cools air within the housing unit by heat transfer between the refrigerant and the air.

31. The method of claim 24, further comprising determining if the housing unit is configured to provide sufficient cooling for the at least one unit of audio-visual equipment.

32. The method of claim 31, wherein determining if the housing unit is configured to provide sufficient cooling includes:
receiving an indication of a maximum safe air temperature;
receiving an indication of an operating power of the audio-visual equipment;
determining an expected air temperature within the housing unit based on the operating power; and
comparing the expected air temperature with the maximum safe air temperature.

33. The method of claim 32, further comprising at least one of raising an alarm, reducing the operating power, and shutting down the at least one unit of audio-visual equipment when the expected air temperature exceeds the maximum safe air temperature.

34. The method of claim 31, wherein determining the expected air temperature within the housing unit based on the operating power includes accounting for heat transfer by at least one of leakage, convection, and radiation.

35. The method of claim 24, further comprising measuring at least one condition related to the housing unit.

36. The method of claim 35, wherein the at least one condition includes at least one of a temperature, a humidity, a pressure, and a power input.

37. The method of claim 24, further comprising receiving at least one indication that the at least one unit of audio-visual equipment is not operating, and controlling the heat exchanger to stop providing the flow of refrigerant in response to receiving the at least one indication.

38. The method of claim 37, wherein the at least on indication includes at least one of an indication of a temperature of air within the housing unit and an indication of a power consumption by the audio-visual equipment.

39. An audio-visual cooling system, comprising:
a refrigerant inlet;
a refrigerant outlet; and
a plurality of structural elements configured to define an arrangement of a housing unit, wherein at least one structural element of the plurality of structural elements includes a means for directing a refrigerant through the at least one structural element between the refrigerant inlet and the refrigerant outlet such that when the refrigerant flows, an air flow within the housing unit may be generated so that heat is transferred away from audio-visual equipment operating within the housing unit through convection.

40. The audio-visual cooling system of claim 39, wherein the at least one structural element includes at least one of a wall of the housing unit, a ceiling of the housing unit, a flooring of the housing unit, a shelf of the housing unit, and a door of the housing unit.

41. The audio-visual cooling system of claim 39, further comprising at least one heat exchanger disposed outside of the housing unit and configured to cool the refrigerant, supply the cooled refrigerant to the refrigerant inlet for use in the refrigerant path, and to accept the used refrigerant from the refrigerant outlet for recooling.

42. The audio-visual cooling system of claim 39, further comprising at least one control system configured to operate the audio-visual cooling system.

43. The audio-visual cooling system of claim 42, wherein the control system is further configured to determine if the audio-visual cooling system is configured to provide sufficient cooling for audio-visual equipment within the housing unit.
